(19) United States
(12) Patent Application Publication
(10) Pub. No.: US 2022/0270028 A1
(43) Pub. Date: Aug. 25, 2022

(54) INFORMATION PROCESSING APPARATUS AND INFORMATION PROCESSING SYSTEM

(71) Applicant: Toshiba Tec Kabushiki Kaisha, Tokyo (JP)

(72) Inventor: Akira TAKAHASHI, Yokohama (JP)

(73) Assignee: Toshiba Tec Kabushiki Kaisha, Tokyo (JP)

(21) Appl. No.: 17/534,945

(22) Filed: Nov. 24, 2021

(30) Foreign Application Priority Data
Feb. 19, 2021 (JP) 2021-025385

(51) Int. Cl. G06Q 10/08; G06K 7/10

(52) U.S. Cl. CPC G06Q 10/087; G06K 7/10366

(57) ABSTRACT

An information processing apparatus includes a processor. The processor is configured to acquire information on a movement history of a commodity based on detection of each movement of the commodity by a sensor, perform a comparison of the number of movements of the commodity based on the information on the movement history of the commodity with a threshold value, and output a notification based on the comparison.

### CROSS-REFERENCE TO RELATED APPLICATION

This application is based upon and claims the benefit of priority from Japanese Patent Application No. 2021-025385, filed on Feb. 19, 2021, the entire contents of which are incorporated herein by reference.

### FIELD

Embodiments described herein relate generally to an information processing apparatus and an information processing system.

### BACKGROUND

In recent years, various measures are taken to prevent spread of infectious diseases caused by a pathogen such as a virus or the like. Among various measures, as main measures to prevent contact infection, there is hygiene management such as sterilization of a commodity or disinfection thereof. Particularly, in commercial facilities, a large number of pieces of merchandise are displayed, and a plurality of customers are expected to contact the merchandise. Therefore, a manager of the commercial facilities is required to sterilize or disinfect a large number of pieces of merchandise that the customer may contact, which requires a lot of time and labor.

On the other hand, a technique exists for detecting an opportunity for the customer to contact merchandise. However, in order to efficiently perform the hygiene management, individual management is required for individual merchandise.

### DESCRIPTION OF THE DRAWINGS

FIG. 1 is a block diagram illustrating an information processing system according to an embodiment;

FIG. 2 is a diagram illustrating movement of merchandise;

FIG. 3 is a diagram illustrating the movement of the merchandise;

FIG. 4 is a block diagram schematically illustrating a configuration example of a server;

FIG. 5 is a block diagram schematically illustrating a configuration example of a reader and writer apparatus;

FIG. 6 is a block diagram schematically illustrating a configuration example of a POS terminal;

FIG. 7 is a diagram illustrating a configuration example of merchandise management information database;

FIG. 8 is a diagram illustrating an example of information stored in a wireless tag attached to the merchandise;

FIG. 9 is a flowchart illustrating a procedure of information processing by the reader and writer apparatus;

FIG. 10 is a flowchart illustrating a procedure of information processing by the server; and

FIG. 11 is a flowchart illustrating a procedure of information processing by the POS terminal.

### DETAILED DESCRIPTION

A technique capable of efficiently performing hygiene management of a commodity is provided.

In general, according to at least one embodiment, an information processing apparatus includes an acquisition unit (e.g., an acquisition device), a comparison unit (e.g., a comparison device), and an output unit (e.g., an output device). The acquisition unit acquires information on a movement history of a commodity based on detection of each movement of the commodity by a sensing device. The comparison unit compares the number of movements of the commodity based on the information on the movement history of the commodity acquired by the acquisition unit with a threshold value. The output unit outputs a notification based on a comparison result of the comparison unit.

Hereinafter, at least one embodiment will be described with reference to the drawings. In each drawing, the same components will be denoted by the same reference signs as much as possible, and duplicate description will be omitted.

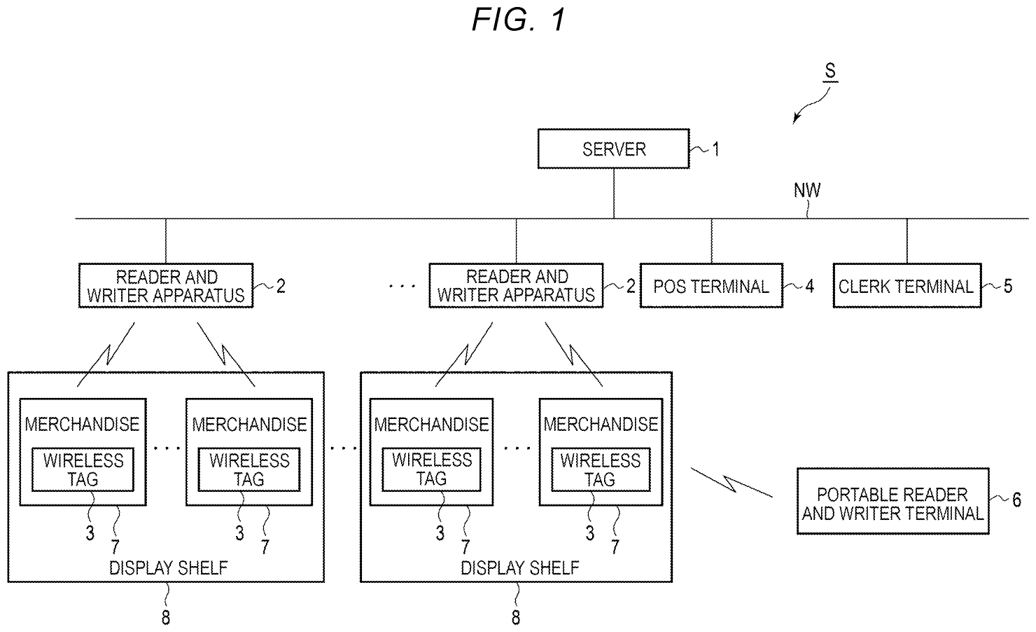

FIG. 1 is a block diagram illustrating an information processing system S according to at least one embodiment.

The information processing system S is a system applicable to a store such as a supermarket or the like.

The information processing system S includes a server 1, a plurality of reader and writer apparatuses 2, a plurality of wireless tags 3, a plurality of point of sales (POS) terminals 4, a clerk terminal 5, and a portable reader and writer terminal 6. The server 1, the plurality of reader and writer apparatuses 2, the plurality of POS terminals 4, and the clerk terminal 5 are connected to each other via a network NW so as to communicate with each other. For example, the network NW is a local area network (LAN), and is not limited thereto. The LAN includes at least one of a wired LAN and a wireless LAN. The server 1 may be provided outside the store. The information processing system S may refer to a system including at least two elements of the server 1, the plurality of reader and writer apparatuses 2, the plurality of wireless tags 3, the plurality of POS terminals 4, the clerk terminal 5, and the portable reader and writer terminal 6. A plurality of pieces of merchandise 7 are displayed in the store. It is assumed that each of the plurality of pieces of merchandise 7 is displayed on any one of a plurality of display shelves 8. Each of the plurality of pieces of merchandise 7 is attached with one wireless tag 3. Attaching the wireless tag 3 thereto indicates that the wireless tag 3 is directly or indirectly attached to the merchandise 7.

The server 1 is an electronic apparatus having an information processing function. The electronic apparatus includes a computer. The server 1 is an example of an information processing apparatus. A configuration example of the server 1 will be described later.

The plurality of reader and writer apparatuses 2 are electronic apparatuses capable of wirelessly communicating with the plurality of wireless tags 3. The plurality of reader and writer apparatuses 2 are installed so as to include the plurality of wireless tags 3 attached to all merchandise 7 displayed in the store within a range in which wireless communication ranges of the plurality of reader and writer apparatuses 2 are combined. Here, it is assumed that one reader and writer apparatus 2 is installed on one display shelf 8. It is assumed that one reader and writer apparatus 2 can wirelessly communicate with the plurality of wireless tags 3 attached to the plurality of pieces of merchandise 7 displayed on the display shelf 8. The reader and writer apparatus 2 is an example of an apparatus provided in a sensing device. A configuration example of the reader and writer apparatus 2 will be described later.

The plurality of wireless tags 3 are tags capable of performing wireless communication with the plurality of reader and writer apparatuses 2 or the portable reader and writer terminal 6. The wireless tag 3 is a merchandise tag. For example, the wireless tag 3 is a radio frequency identification (RFID) tag. A tag ID is assigned to each wireless tag 3. Hereinafter, the tag ID assigned to the wireless tag 3 is also referred to as a merchandise tag ID. The merchandise tag ID is identification information with which the wireless tag 3 is individually identified. The merchandise tag ID can also be used as identification information with which the merchandise 7 is individually identified. The wireless tag 3 includes a chip, an antenna, or the like. The chip controls the wireless tag 3. The chip includes a storage area of data. The storage area stores the merchandise tag ID. The antenna is used to wirelessly communicate with an external apparatus. The antenna is used for receiving power supply from the external apparatus. The wireless tag 3 is activated by receiving a radio wave from the external apparatus via the antenna. The wireless tag 3 communicates with the external apparatus by activation thereof. The wireless tag 3 is an example of an information recording medium. An example of information other than the tag ID stored in the wireless tag 3 will be described later.

The plurality of POS terminals 4 are electronic apparatuses capable of performing settlement of the merchandise 7. The settlement is payment of a price for the merchandise 7. The settlement includes the meaning of check-out. The POS terminal 4 supports both offline settlement and online settlement. The offline settlement is settlement in which the POS terminal 4 does not require cooperation with other electronic apparatuses via the Internet or the like. For example, the offline settlement is settlement by cash, gift certificate, or the like. The online settlement is settlement executed by the POS terminal 4 in cooperation with other electronic apparatuses via the Internet or the like. For example, the online settlement includes credit card settlement, electronic money settlement, debit card settlement, code settlement, or the like. The online settlement corresponds to cashless settlement. The POS terminal 4 is an example of the information processing apparatus. A configuration example of the POS terminal 4 will be described later.

The clerk terminal 5 is an electronic apparatus having a communication function, an input function, a display function, or the like with other electronic apparatuses via the network NW. The clerk terminal 5 is used by a clerk in the store. For example, the clerk terminal 5 is a personal computer (PC), and may be a smartphone, a tablet terminal, or the like.

The portable reader and writer terminal 6 is a portable electronic apparatus capable of wirelessly communicating with the plurality of wireless tags 3. The portable reader and writer terminal 6 is used for searching for the merchandise 7.

Movement of the merchandise 7 detected by the reader and writer apparatus 2 will be described.

The movement of the merchandise 7 indicates that a customer C moves the merchandise 7 displayed on the display shelf 8 from the display shelf 8. The movement of the merchandise 7 includes a series of behaviors in which the customer picks up, by the hand, the merchandise 7 displayed on the display shelf 8 and returns the merchandise 7 to the display shelf 8. Picking up the merchandise 7 by the hand includes moving the merchandise 7 from a display place of the display shelf 8. Returning the merchandise 7 to the display shelf 8 includes returning the merchandise 7 to the same or almost the same place as an original display place of the display shelf 8. The movement of the merchandise 7 may include a behavior until the customer picks up, by the hand, the merchandise 7 displayed on the display shelf 8. The latter example is an example in which the customer does not return the merchandise 7 to the display shelf 8. The movement of the merchandise 7 is detected by wireless communication between the reader and writer apparatus 2 and the wireless tag 3 attached to the merchandise 7. Since the wireless tag 3 is attached to the merchandise 7, the movement of the merchandise 7 indicates movement of the wireless tag 3. Description of “the movement of the merchandise 7” and description of “the movement of the wireless tag 3” can be replaced with each other. The customer may be replaced with a member, a consumer, or a person. An example of detecting the movement of the merchandise 7 by the reader and writer apparatus 2 will be described later.

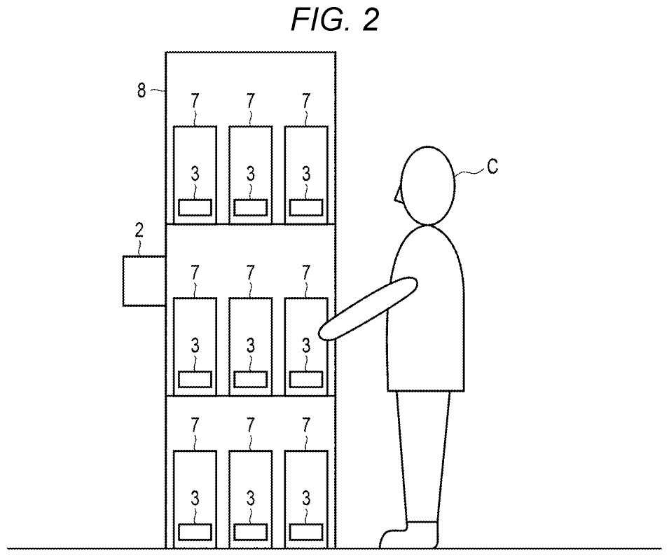

FIG. 2 is a diagram illustrating the movement of the merchandise 7 according to at least one embodiment.

FIG. 2 illustrates a state in which the customer C tries to pick up, by the hand, the merchandise 7 displayed on any display shelf 8.

The reader and writer apparatus 2 is installed at any location on the display shelf 8. The reader and writer apparatus 2 can wirelessly communicate with the wireless tag 3 attached to each of all the merchandise 7 displayed on the display shelf 8.

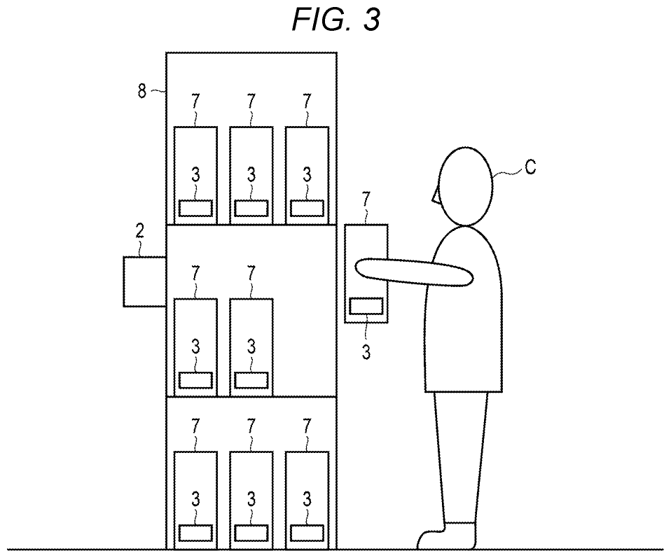

FIG. 3 is a diagram illustrating the movement of the merchandise 7 according to at least one embodiment.

FIG. 3 illustrates a state in which the customer C picks up, by the hand, the merchandise 7 displayed on any display shelf 8.

A configuration example of the server 1 will be described.

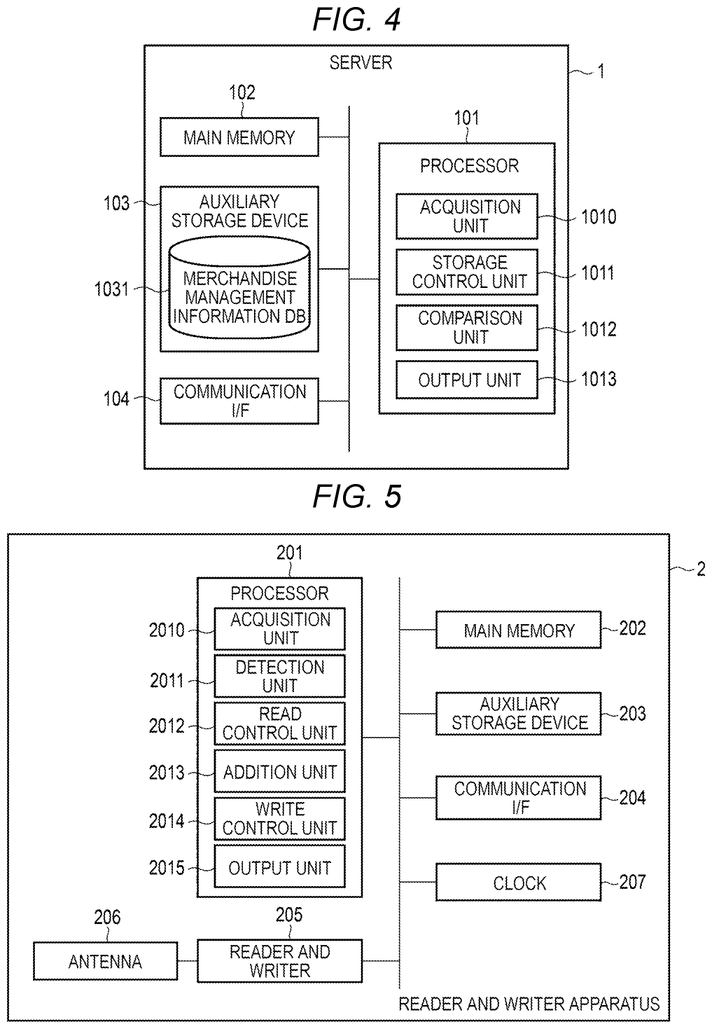

FIG. 4 is a block diagram schematically illustrating the configuration example of the server 1 according to at least one embodiment.

The server 1 is an electronic apparatus including a processor 101, a main memory 102, an auxiliary storage device 103, and a communication interface 104. The respective units forming the server 1 are connected to each other so that a signal can be input and output. In FIG. 1, the interface is described as “I/F”.

The processor 101 corresponds to a central portion of the server 1. For example, the processor 101 is a central processing unit (CPU) (e.g., a central processor), and is not limited thereto. The processor 101 may be formed of various circuits. The processor 101 loads a program, which is stored in advance in the main memory 102 or the auxiliary storage device 103, in the main memory 102. The program is a program that causes the processor 101 of the server 1 to implement or execute each unit which will be described later. The processor 101 executes various operations by executing the program loaded in the main memory 102.

The main memory 102 corresponds to a main memory portion of the server 1. The main memory 102 includes a non-volatile memory area and a volatile memory area. The main memory 102 stores an operating system or a program in the non-volatile memory area. The main memory 102 uses the volatile memory area as a work area where data is appropriately rewritten by the processor 101. For example, the main memory 102 includes a read only memory (ROM) as the non-volatile memory area. For example, the main memory 102 includes a random access memory (RAM) as the volatile memory area. The main memory 102 stores the program.

The auxiliary storage device 103 corresponds to an auxiliary storage portion of the server 1. The auxiliary storage device 103 is an electric erasable programmable read-only memory (EEPROM) (registered trademark), a hard disk drive (HDD), a solid state drive (SSD), or the like. The auxiliary storage device 103 stores the above-described program, data used by the processor 101 to perform various processing, and data generated by the processing of the processor 101. The auxiliary storage device 103 stores the above-described program. The auxiliary storage device 103 is an example of a storage unit (e.g., a memory).

The auxiliary storage device 103 includes a merchandise management information database 1031.

The merchandise management information database 1031 is a database that manages the movement of each merchandise 7 after each merchandise 7 is displayed on any display shelf 8. The merchandise management information database 1031 includes a merchandise tag ID and a record forming data correlated with movement history information.

The merchandise tag ID is identification information assigned to each wireless tag 3 attached to the merchandise 7 as described above.

The movement history information is information on movement history of the merchandise 7. The movement history information is information that changes based on detection for each movement of the merchandise 7 by the reader and writer apparatus 2. The movement history information includes at least one of information on the number of movements and movement date and time history information.

The information on the number of movements is information on the number of movements of the merchandise 7. The number of movements of the merchandise 7 is the number of times that the detection of the movement of the merchandise 7 by the reader and writer apparatus 2 is counted. For example, the number of movements of the merchandise 7 is the number of times that the reader and writer apparatus 2 detects a series of operations in which the customer picks up, by the hand, the merchandise 7 displayed on the display shelf 8 and returns the merchandise 7 to the display shelf 8. In this example, the number of movements of the merchandise 7 is the total number of times that this behavior is performed by the same customer or a different customer, in which this operation is counted as one time. The number of movements of the merchandise 7 may be the number of times that the reader and writer apparatus 2 detects the behavior in which the customer picks up, by the hand, the merchandise 7 displayed on the display shelf 8. In this example, the number of movements of the merchandise 7 is the total number of times that this operation is performed by the same customer or a different customer, in which this operation is counted as one time.

The movement date and time history information is information indicating a history of a movement date and time. The movement date and time is a date and time when the merchandise 7 is moved by the customer. The history of the movement date and time is the movement date and time for each movement of the merchandise 7. For example, the movement date and time is the date and time when the movement of the merchandise 7 is detected by the reader and writer apparatus 2. The movement date and time history information includes movement date and time information for each movement of the merchandise 7. The movement date and time information is information indicating the movement date and time.

The merchandise management information database 1031 is an example of a storage unit (e.g., a memory). The auxiliary storage device 103 is not limited to the merchandise management information database 1031, and may store the movement history information correlated with each merchandise tag ID. Description of the merchandise management information database 1031 may be appropriately replaced with the auxiliary storage device 103. A configuration example of the merchandise management information database 1031 will be described later.

The communication interface 104 includes various interfaces that connect the server 1 to other electronic apparatuses to be able to communicate with each other via a network according to a predetermined communication protocol.

A hardware configuration of the server 1 is not limited to the above-described configuration. The server 1 can appropriately omit and modify the above-described components and add a new component.

Each unit installed on the processor 101 will be described.

The processor 101 is installed with an acquisition unit 1010 (e.g., an acquisition device), a storage control unit 1011 (e.g., a storage controller), a comparison unit 1012 (e.g., a comparison device), and an output unit 1013 (e.g., an output device). Each unit installed on the processor 101 can also be referred to as each function. Each unit installed on the processor 101 can also be installed on a control unit (e.g., a controller) including the processor 101 and the main memory 102.

The acquisition unit 1010 acquires various pieces of information. For example, the acquisition unit 1010 acquires movement information from the reader and writer apparatus 2 via the communication interface 104. The movement information is information on the movement of the merchandise 7. The movement information includes at least one of the information on the number of movements and the movement date and time information. The movement information is information based on the detection of the movement of the merchandise 7 by the reader and writer apparatus 2. The movement information is information output by the reader and writer apparatus 2. The acquisition unit 1010 acquires the movement information in response to the detection of the movement of the merchandise 7 by the reader and writer apparatus 2. For example, the acquisition unit 1010 acquires the movement history information from the merchandise management information database 1031. In the following description, “in response to” may be replaced with “based on.”

The storage control unit 1011 updates the movement history information stored in the merchandise management information database 1031 based on the movement information from the reader and writer apparatus 2. Each time the movement information is acquired by the acquisition unit 1010, the storage control unit 1011 stores the movement information in correlation with the merchandise tag ID in the merchandise management information database 1031. The storage control unit 1011 updates the movement history information every time the movement information is stored in the merchandise management information database 1031.

The comparison unit 1012 compares the number of movements of the merchandise 7 based on the movement history information acquired by the acquisition unit 1010 with a threshold value. The threshold value is an index value related to the number of movements of the merchandise 7. The index value related to the number of movements of the merchandise 7 is an index value based on necessity for performing hygiene management of the merchandise 7. For example, the number of movements of the merchandise 7 indicates that as the number of movements becomes larger, the number of times that the customer contacts the merchandise 7 becomes larger, and as the number of movements becomes larger, the necessity for performing the hygiene management becomes higher. A state in which the number of movements of the merchandise 7 is less than the threshold value corresponds to a state in which the necessity for performing the hygiene management of the merchandise 7 is low. A state in which the number of movements of the merchandise 7 is equal to or greater than the threshold value corresponds to a state in which the necessity for performing the hygiene management of the merchandise 7 is high. For example, the threshold value may be set low in a situation where a risk of infectious disease of the merchandise 7 is high. On the other hand, the threshold may be set high in a situation where the risk of infectious disease thereof is low. The necessity for performing the hygiene management of the merchandise 7 corresponds to a priority of performing the hygiene management of the merchandise 7. The threshold value may be set in advance, or may be appropriately set or updated by a manager.

The output unit 1013 outputs a notification based on a comparison result of the comparison unit 1012 via the communication interface 104. The notification is a notification related to the movement of the merchandise 7 based on the number of movements which is equal to or greater than the threshold value. For example, the notification is a notification for encouraging the clerk to perform the hygiene management. The notification may include information such as information on the number of movements of the merchandise 7, information on the date and time of the last movement of the merchandise 7, or the like.

A configuration example of the reader and writer apparatus 2 will be described.

FIG. 5 is a block diagram schematically illustrating the configuration example of the reader and writer apparatus 2 according to at least one embodiment.

The reader and writer apparatus 2 is an electronic apparatus including a processor 201, a main memory 202, an auxiliary storage device 203, a communication interface 204, a reader and writer 205, an antenna 206, and a clock 207. The processor 201, the main memory 202, the auxiliary storage device 203, the communication interface 204, the reader and writer 205, and the clock 207 are connected to each other so that a signal can be input and output. The reader and writer 205 and the antenna 206 are electrically connected to each other. In FIG. 5, the interface is described as “I/F”.

The processor 201 corresponds to a central portion of the reader and writer apparatus 2. The processor 201 has the same hardware configuration as that of the processor 101. The processor 201 loads a program, which is stored in advance in the main memory 202 or the auxiliary storage device 203, in the main memory 202. The program is a program that causes the processor 201 of the reader and writer apparatus 2 to implement or execute each unit which will be described later. The processor 201 executes various operations by executing the program loaded in the main memory 202.

The main memory 202 corresponds to a main memory portion of the reader and writer apparatus 2. The main memory 202 has the same hardware configuration as that of the main memory 102. The main memory 202 stores the program.

The auxiliary storage device 203 corresponds to an auxiliary storage portion of the reader and writer apparatus 2. The auxiliary storage device 203 has the same hardware configuration as that of the auxiliary storage device 103. The auxiliary storage device 203 stores the above-described program, data used by the processor 201 to perform various processing, and data generated by the processing of the processor 201.

The communication interface 204 includes various interfaces that connect the reader and writer apparatus 2 to other electronic apparatuses to be able to communicate with each other via a network according to a predetermined communication protocol.

The reader and writer 205 is an electronic apparatus that wirelessly communicates with the wireless tag 3 through the antenna 206. For example, the reader and writer 205 emits a transmission wave through the antenna 206. The reader and writer 205 receives a response wave with respect to the transmission wave from the wireless tag 3 through the antenna 206 and demodulates the response wave. The reader and writer 205 acquires data from the wireless tag 3 by demodulating the response wave. The reader and writer 205 reads information stored in the wireless tag 3 from the wireless tag 3. The wireless tag 3 stores the merchandise ID and the movement history information. The reader and writer 205 measures a radio wave intensity from the wireless tag 3. The reader and writer 205 acquires the intensity of the response wave from the wireless tag 3 as the radio wave intensity. The radio wave intensity is also referred to as a reception intensity. The reader and writer 205 transmits predetermined data to the wireless tag 3 based on a signal from the processor 201. For example, the reader and writer 205 transmits a signal in which write data is encoded to the wireless tag 3 through the antenna 206.

The antenna 206 is an antenna for allowing the reader and writer 205 to wirelessly communicate with the wireless tag 3.

The clock 207 functions as a time information source for the reader and writer apparatus 2. The processor 201 tracks a current date and time based on information on time tracked by the clock 207.

A hardware configuration of the reader and writer apparatus 2 is not limited to the above-described configuration. The reader and writer apparatus 2 can appropriately omit and modify the above-described components and add a new component.

Each unit installed on the processor 201 will be described.

The processor 201 is installed with an acquisition unit 2010 (e.g., an acquisition device), a detection unit 2011 (e.g., a detection device), a read control unit 2012 (e.g., a read controller), an addition unit 2013 (e.g., an addition device), a write control unit 2014 (e.g., a write controller), and an output unit 2015 (e.g., an output device). Each unit installed on the processor 201 can also be referred to as each function. Each unit installed on the processor 201 can also be installed on a control unit (e.g., a controller) including the processor 201 and the main memory 202.

The acquisition unit 2010 acquires a measurement result of the radio wave intensity of the wireless tag 3 from the reader and writer 205. The acquisition unit 2010 acquires the measurement result of the radio wave intensity in response to the measurement of the radio wave intensity of the wireless tag 3 by the reader and writer 205. The measurement result is a measurement value of the radio wave intensity of the wireless tag 3. The measurement value of the radio wave intensity is also simply referred to as a radio wave intensity.

The detection unit 2011 detects the movement of the merchandise 7 based on the measurement result of the radio wave intensity of the wireless tag 3 acquired by the acquisition unit 2010.

The read control unit 2012 controls the reader and writer 205 to read information from the wireless tag 3 via the antenna 206. For example, the read control unit 2012 reads the information stored in the wireless tag 3 from the wireless tag 3. The read control unit 2012 reads the merchandise tag ID from the wireless tag 3. The read control unit 2012 reads the information on the number of movements from the wireless tag 3. In the following description, “read” may be replaced with “receive”.

The addition unit 2013 adds 1 to the number of movements indicated by the information on the number of movements read by the read control unit 2012. The addition unit 2013 acquires new information on the number of movements based on addition processing of adding one to the number of movements.

The write control unit 2014 controls the reader and writer 205 to write the information to the wireless tag 3. For example, the write control unit 2014 writes the movement information to the wireless tag 3. In the following description, “write” may be replaced with “transmit” or “output”.

The output unit 2015 outputs the merchandise tag ID of the wireless tag 3 and the movement information to the server 1 via the communication interface 204.

A configuration example of the POS terminal 4 will be described.

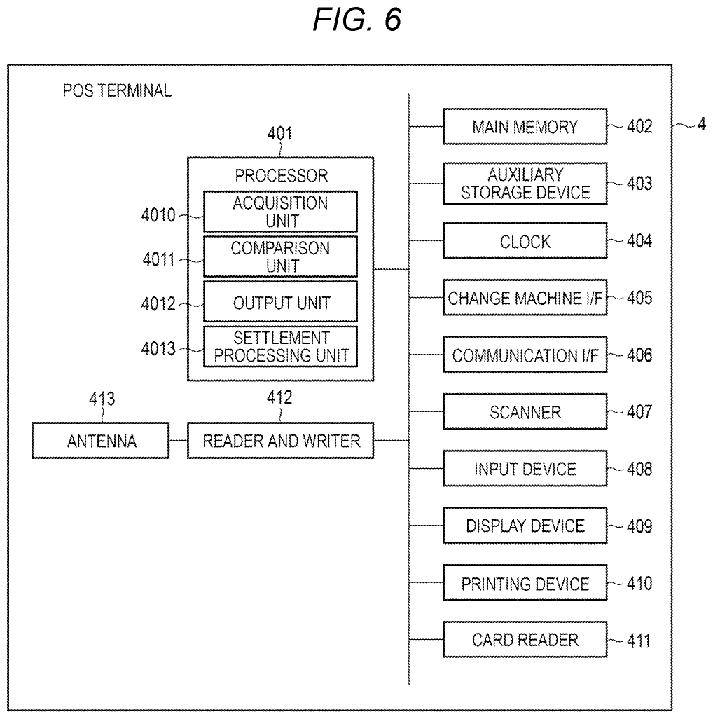

FIG. 6 is a block diagram schematically illustrating the configuration example of the POS terminal 4 according to at least one embodiment.

The POS terminal 4 is an electronic apparatus including a processor 401, a main memory 402, an auxiliary storage device 403, a clock 404, a change machine interface 405, a communication interface 406, an input device 408, a display device 409, a printing device 410, a scanner 407, a card reader 411, a reader and writer 412, and an antenna 413. The processor 401, the main memory 402, the auxiliary storage device 403, the clock 404, the change machine interface 405, the communication interface 406, the input device 408, the display device 409, the printing device 410, the scanner 407, the card reader 411, and the reader and writer 412 are connected to each other so that a signal can be input and output. The reader and writer 412 and the antenna 413 are electrically connected to each other. In FIG. 6, the interface is described as “I/F”.

The processor 401 corresponds to a central portion of the POS terminal 4. The processor 401 has the same hardware configuration as that of the processor 101. The processor 401 loads a control program, which is stored in advance in the main memory 402 or the auxiliary storage device 403, in the main memory 402. The program is a program that causes the processor 401 of the POS terminal 4 to implement or execute each unit which will be described later. The processor 401 executes various operations by executing the control program loaded in the main memory 402.

The main memory 402 corresponds to a main memory portion of the POS terminal 4. The main memory 402 has the same hardware configuration as that of the main memory 102. The main memory 402 stores the program.

The auxiliary storage device 403 corresponds to an auxiliary storage portion of the POS terminal 4. The auxiliary storage device 403 has the same hardware configuration as that of the auxiliary storage device 103. The auxiliary storage device 403 stores the above-described program, data used by the processor 401 for performing various processing, and data generated by the processing of the processor 401.

The clock 404 functions as a time information source for the POS terminal 4. The processor 401 tracks a current date and time based on information on time tracked by the clock 404.

The change machine interface 405 performs input and output of a data signal between the change machine interface 405 and an automatic change machine which is not illustrated. For example, the change machine interface 405 inputs input amount data from the automatic change machine. The change machine interface 405 outputs change amount data to the automatic change machine. In the automatic change machine, a bill or a coin equivalent to a change amount according to the change amount data are paid out.

The communication interface 406 includes various interfaces that connect the POS terminal 4 to other electronic apparatuses to be able to communicate with each other via a network according to a predetermined communication protocol.

The scanner 407 scans and reads a barcode or the like of the merchandise held over a reading window. Merchandise sold in a store is attached with a barcode symbol obtained by barcoding a merchandise code for identifying the merchandise. The scanner 407 reads the barcode each time the barcode symbol attached to the merchandise is held over the reading window. Here, the barcode may be replaced with a two-dimensional data code. The scanner 407 may be formed in a type that reads a code symbol by laser beam scanning. The scanner 407 may be formed in a type that reads a code symbol from an image captured by an imaging device such as a camera or the like.

The input device 408 is a device that functions as a data input interface to the POS terminal 4. For example, the input device 408 is a keyboard, a touch panel, or the like.

The display device 409 is a device capable of displaying various screens under the control of the processor 401. In the display device 409, a device for a clerk and a device for a customer may be separately provided. For example, the display device 409 is a liquid crystal display, an electroluminescence (EL) display, or the like.

The printing device 410 is a device for printing a receipt, a slip, or the like. For example, the printing device 410 is a thermal printer, an inkjet printer, or the like.

The card reader 411 reads card data recorded on a magnetic stripe of a card medium.

The reader and writer 412 reads the information stored in the wireless tag 3 from the wireless tag 3. The reader and writer 412 has the same hardware configuration as that of the reader and writer 205.

The antenna 413 is an antenna for the reader and writer 412 to wirelessly communicate with the wireless tag 3. The antenna 413 has the same hardware configuration as that of the antenna 206.

A hardware configuration of the POS terminal 4 is not limited to the above-described configuration. The POS terminal 4 can appropriately omit and modify the above-described components and add a new component.

Each unit installed on the processor 401 will be described.

The processor 401 is installed with an acquisition unit 4010 (e.g., an acquisition device or receiver), a comparison unit 4011 (e.g., a comparison unit), an output unit 4012 (e.g., an output unit), and a settlement processing unit 4013 (e.g., a settlement processor). Each unit installed on the processor 401 can also be referred to as each function. Each unit installed on the processor 401 can also be installed on a control unit including the processor 401 and the main memory 402.

The acquisition unit 4010 acquires various pieces of information via the reader and writer 412. For example, the acquisition unit 4010 acquires the merchandise tag ID from the wireless tag 3. The acquisition unit 4010 acquires the movement history information from the wireless tag 3.

In the same manner as that of the comparison unit 1012, the comparison unit 4011 compares the number of movements of the merchandise based on the movement history information acquired by the acquisition unit 4010 with a threshold value. The threshold value may be the same as the above-described threshold value used in the comparison unit 1012.

The output unit 4012 outputs a notification to the display device 409 based on a comparison result of the comparison unit 4011. The notification is a notification related to the movement of the merchandise 7 based on the number of movements which is equal to or greater than the threshold value. For example, the notification is a notification for encouraging the clerk to exchange the merchandise 7. The notification may include information such as information on the number of movements of the merchandise 7, information on the date and time of the last movement of the merchandise 7, or the like.

The settlement processing unit 4013 executes settlement processing. For example, the settlement processing unit 4013 executes the settlement processing according to selection of a payment method by the customer. The payment method includes offline settlement and online settlement.

The configuration example of the merchandise management information database 1031 will be described.

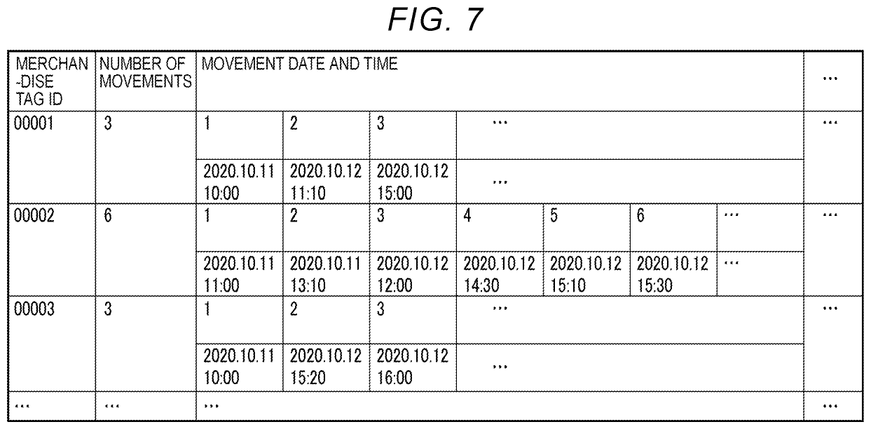

FIG. 7 is a diagram illustrating the configuration example of the merchandise management information database 1031 according to at least one embodiment.

The merchandise management information database 1031 includes a “merchandise tag ID” item, a “number of movements” item, and a “movement date and time” item. The “merchandise tag ID” item is an item for setting the merchandise tag ID. The “number of movements” item is an item for setting the information on the number of movements. The “movement date and time” item is an item for setting the movement date and time history information. The “movement date and time” item includes one or more movement dates and times indicated by the movement date and time history information. Each of the plurality of merchandise tag IDs is correlated with the information on the number of movements and the movement date and time history information as the movement history information record by the merchandise management information database 1031. For example, according to storage contents of the merchandise management information database 1031, the number of movements of a merchandise tag ID “00001” is three times, and the respective movement dates and times thereof are “October 11, 2020, 10:00”, “October 12, 2020, 11:10”, and “October 12, 2020, 15:00”. The movement date and time indicated by the movement date and time history information may be deleted after a certain period of time elapses under the control of the storage control unit 1011. For example, the movement date and time may be deleted from the merchandise management information database 1031 when 24 hours elapse from the movement date and time. The merchandise management information database 1031 may include at least one of the “number of movements” item and the “movement date and time” item. The information in the merchandise management information database 1031 can be appropriately set. The server 1 appropriately updates the merchandise management information database 1031.

If the wireless tag 3 does not store the movement history information, the server 1 stores the movement history information. On the other hand, if the wireless tag 3 stores the movement history information, the server 1 may or may not store the movement history information.

An example of the information stored in the wireless tag 3 will be described.

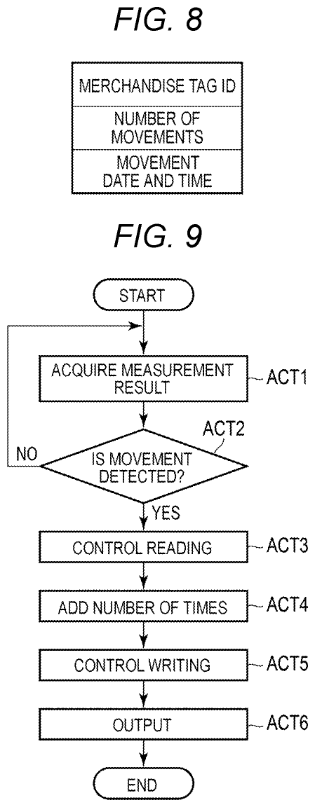

FIG. 8 is a diagram illustrating the example of the information stored in the wireless tag 3 according to at least one embodiment.

The wireless tag 3 includes a “merchandise tag ID” item, a “number of movements” item, and a “movement date and time” item. The merchandise tag ID is correlated with the information on the number of movements and the movement date and time history information. The “tag ID” item, the “number of movements” item, and the “movement date and time” item are configured with the same data as each item provided in the merchandise management information database 1031. The wireless tag 3 may include at least one of the “number of movements” item and the “movement date and time” item. The information in the wireless tag 3 can be appropriately set. The information in the wireless tag 3 is appropriately updated by communication with the reader and writer apparatus 2, the POS terminal 4, or the portable reader and writer terminal 6.

If the server 1 does not store the movement history information, the wireless tag 3 stores the movement history information. On the other hand, if the server 1 stores the movement history information, the wireless tag 3 may or may not store the movement history information.

A procedure of processing by the information processing system S will be described.

In the following description where the server 1 is a main subject, the server 1 may be replaced with the processor 101. In the same manner, in the description where the reader and writer apparatus 2 is a main subject, the reader and writer apparatus 2 may be replaced with the processor 201. In the same manner, in the description where the POS terminal 4 is a main subject, the POS terminal 4 may be replaced with the processor 401. A processing procedure described below is only an example, and each processing may be modified as much as possible. With respect to the processing procedure described below, ACTs can appropriately be omitted, replaced, and added according to at least one embodiment.

Here, it is assumed that movement of merchandise 71, to which a wireless tag 31 of the merchandise tag ID “00001” is attached among the plurality of pieces of merchandise 7, is detected. The customer C picks up, by the hand, the merchandise 71 displayed on the display shelf 8. The reader and writer apparatus 2 installed on the display shelf 8 measures a radio wave intensity of the wireless tag 31 attached to the merchandise 71.

First, a procedure of information processing by the reader and writer apparatus 2 will be described.

FIG. 9 is a flowchart illustrating the procedure of the information processing by the reader and writer apparatus 2 according to at least one embodiment.

The acquisition unit 2010 acquires a measurement result of the radio wave intensity of the wireless tag 31 from the reader and writer 205 (ACT 1). In ACT 1, for example, the acquisition unit 2010 acquires the measurement result of the radio wave intensity in response to the measurement of the radio wave intensity of the wireless tag 31 by the reader and writer 205. In one example, the acquisition unit 2010 acquires a measurement result indicating a decrease and increase in the radio wave intensity of the wireless tag 31 as the customer C picks up, by the hand, the merchandise 71 displayed on the display shelf 8 and returns the merchandise 71 to the display shelf 8. In another example, the acquisition unit 2010 acquires a measurement result indicating a decrease in the radio wave intensity of the wireless tag 31 as the customer C picks up, by the hand, the merchandise 71 displayed on the display shelf 8.

The detection unit 2011 detects the movement of the merchandise 71 based on the measurement result of the radio wave intensity of the wireless tag 31 acquired by the acquisition unit 2010 (ACT 2). In ACT 2, for example, the detection unit 2011 detects the movement of the merchandise 71 according to a change in the radio wave intensity of the wireless tag 31 based on the measurement result acquired by the acquisition unit 2010. In one example, the detection unit 2011 detects the movement of the merchandise 71 based on the measurement result indicating the decrease and increase in the radio wave intensity of the wireless tag 31 acquired by the acquisition unit 2010. In another example, the detection unit 2011 detects the movement of the merchandise 71 based on the measurement result indicating the decrease in the radio wave intensity of the wireless tag 31 acquired by the acquisition unit 2010.

If the detection unit 2011 detects the movement of the merchandise 71 (ACT 2: YES), the processing shifts from ACT 2 to ACT 3. If the detection unit 2011 does not detect the movement of the merchandise 71 (ACT 2: NO), the processing shifts from ACT 2 to ACT 1.

The read control unit 2012 controls the reader and writer 205 based on the detection of the movement of the merchandise 71 by the detection unit 2011, and reads information from the wireless tag 31 (ACT 3). In ACT 3, for example, the read control unit 2012 controls the reader and writer 205, and establishes communication with the wireless tag 31 attached to the merchandise 71 of which movement is detected via the antenna 206. The read control unit 2012 reads the merchandise tag ID and the information on the number of movements from the wireless tag 31. Since reading the data from the wireless tag is a well-known technique, details thereof will be omitted.

The addition unit 2013 adds 1 to the number of movements of the wireless tag 31 (ACT 4). In ACT 4, for example, the addition unit 2013 adds 1 to the number of movements indicated by the information on the number of movements, based on the information on the number of movements read from the wireless tag 31 by the read control unit 2012. The addition unit 2013 acquires new information on the number of movements based on the processing of adding one to the number of movements.

The write control unit 2014 controls the reader and writer 205 based on the detection of the movement of the merchandise 71 by the detection unit 2011, and writes the movement information of the merchandise 71 to the wireless tag 31 (ACT 5). In ACT 5, for example, the write control unit 2014 controls the reader and writer 205, and establishes communication with the wireless tag 31 based on the merchandise tag ID via the antenna 206. The write control unit 2014 controls the reader and writer 205, and writes the information on the number of movements based on the addition processing by the addition unit 2013 to the wireless tag 31. The write control unit 2014 controls the reader and writer 205, and writes a date and time when the movement of the merchandise 71 is detected by the detection unit 2011 as the movement date and time information to the wireless tag 31. The write control unit 2014 may control the reader and writer 205, and write at least one of the information on the number of movements and the movement date and time information to the wireless tag 31. The wireless tag 31 stores the movement history information based on the movement information of the merchandise 71. The wireless tag 31 sets the received information on the number of movements in the “number of movements” item based on the reception of the information on the number of movements in the movement information of the merchandise 71. The number of movements increases by one by writing the information on the number of movements by the reader and writer apparatus 2. The wireless tag 31 sets the received movement date and time information in the “movement date and time” item based on the reception of the movement date and time information in the movement information of the merchandise 71. The number of movement dates and times indicated by the movement date and time history information increases by one by writing the movement date and time information by the reader and writer apparatus 2. Controlling the reader and writer 205 by the write control unit 2014 to write at least one of the information on the number of movements and the movement date and time information to the wireless tag 31 corresponds to outputting the movement information of the merchandise 71 to the wireless tag 31 attached to the merchandise 71. Since writing data to the wireless tag 31 is a well-known technique, details thereof will be omitted.

The output unit 2015 outputs the movement information of the merchandise 71 to the server 1 via the communication interface 204 based on the detection of the movement of the merchandise 71 by the detection unit 2011 (ACT 6). In ACT 6, for example, the output unit 2015 outputs the merchandise tag ID of the wireless tag 31 attached to the merchandise 71 and the movement information of the merchandise 71 to the server 1. The output unit 2015 outputs, to the server 1, at least one of the information on the number of movements and the movement date and time information. The output unit 2015 may output the information on the number of movements based on the addition processing by the addition unit 2013 to the server 1. The output unit 2015 may output, as the movement date and time information, the date and time when the movement of the merchandise 71 is detected by the detection unit 2011 to the server 1.

If the wireless tag 31 does not store the information on the number of movements, ACT 3 and ACT 4 are omitted. If the wireless tag 31 does not store the movement history information, ACT 3, ACT 4, and ACT 5 are omitted. If the server 1 does not store the movement history information, ACT 6 is omitted.

According to this example, the reader and writer apparatus 2 can output the movement information of the merchandise 71 based on the detection of the movement of the merchandise 71 by the write control unit 2014 or the output unit 2015.

In one example, the reader and writer apparatus 2 can output the movement information of the merchandise 71 to the wireless tag 31 based on the detection of the movement of the merchandise 71. As a result, the wireless tag 31 can store the movement history information based on the movement information of the merchandise 71. The POS terminal 4 or the portable reader and writer terminal 6 that reads the wireless tag 31 can allow a clerk to identify merchandise that has a large number of customer contacts and high necessity for performing hygiene management from the movement history information of the merchandise 71. Therefore, the reader and writer apparatus 2 can provide support for allowing the clerk to efficiently perform the hygiene management of the merchandise.

In another example, the reader and writer apparatus 2 can output the movement information of the merchandise 71 to the server 1 based on the detection of the movement of the merchandise 71. Accordingly, the server 1 can store the movement history information based on the movement information of the merchandise 71. The server 1 can manage the movement history information based on the movement information of each merchandise 71. From the movement history information of the merchandise, the server 1 can notify the clerk of the merchandise that has a large number of customer contacts and high necessity for performing hygiene management. Therefore, the reader and writer apparatus 2 can provide support for allowing the clerk to efficiently perform the hygiene management of the merchandise.

Next, a procedure of information processing by the server 1 will be described.

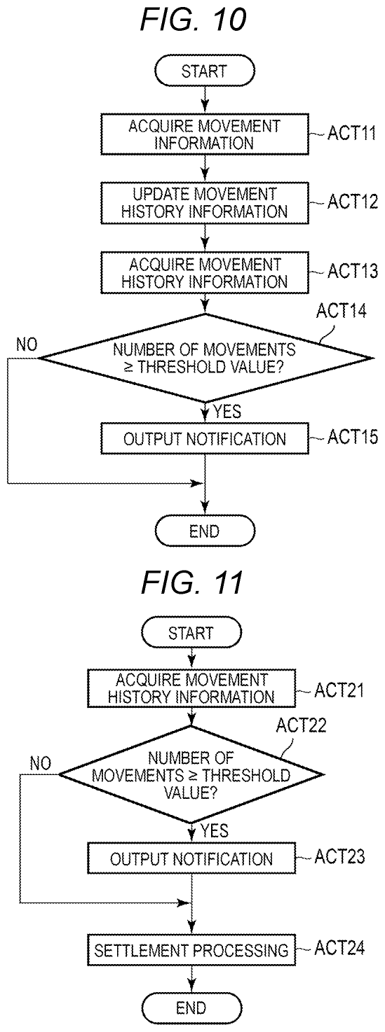

FIG. 10 is a flowchart illustrating the procedure of the information processing by the server 1 according to at least one embodiment.

The processing illustrated in FIG. 10 is applied to an example in which the server 1 stores the movement history information.

The acquisition unit 1010 acquires the movement information of the merchandise 71 from the reader and writer apparatus 2 via the communication interface 104 (ACT 11). In ACT 11, for example, the acquisition unit 1010 acquires the merchandise tag ID of the wireless tag 31 and the movement information of the merchandise 71 based on the detection of the movement of the merchandise 71 by the reader and writer apparatus 2. The acquisition unit 1010 acquires at least one of the information on the number of movements and the movement date and time information from the reader and writer apparatus 2.

The storage control unit 1011 updates the movement history information stored in the merchandise management information database 1031 based on the movement information from the reader and writer apparatus 2 acquired by the acquisition unit 1010 (ACT 12). In ACT 12, for example, the storage control unit 1011 updates the movement history information correlated with the merchandise tag ID of the wireless tag 31 acquired by the acquisition unit 1010.

A case in which the movement information acquired by the acquisition unit 1010 includes the information on the number of movements will be described. The storage control unit 1011 updates the information on the number of movements stored in the merchandise management information database 1031 to the information on the number of movements acquired by the acquisition unit 1010. The number of movements indicated by the information on the number of movements after the update increases by one from the number of movements indicated by the information on the number of movements before the update.

A case in which the movement information acquired by the acquisition unit 1010 includes the movement date and time information will be described. The storage control unit 1011 updates the movement date and time history information stored in the merchandise management information database 1031 based on the movement date and time information acquired by the acquisition unit 1010. The storage control unit 1011 adds the movement date and time indicated by the movement date and time information acquired by the acquisition unit 1010 to the movement date and time history information. The number of movement dates and times indicated by the movement date and time history information after the update increases by one from the number of movement dates and times indicated by the movement date and time information before the update.

A case in which the movement information acquired by the acquisition unit 1010 does not include the information on the number of movements and includes the movement date and time information will be described. The storage control unit 1011 may update the information on the number of movements by adding one to the number of movements indicated by the information on the number of movements stored in the merchandise management information database 1031. The number of movements indicated by the information on the number of movements after the update increases by one from the number of movements indicated by the information on the number of movements before the update.

The acquisition unit 1010 acquires the movement history information of the merchandise 71 from the merchandise management information database 1031 (ACT 13). In ACT 13, for example, the acquisition unit 1010 acquires at least one of the information on the number of movements and the movement date and time history information based on the update of the movement history information of the merchandise 71 by the storage control unit 1011.

The comparison unit 1012 compares the number of movements of the merchandise 71 based on the movement history information of the merchandise 71 acquired by the acquisition unit 1010 with a threshold value (ACT 14). In ACT 14, for example, the comparison unit 1012 compares the number of movements of the merchandise 71 with the threshold value each time the movement history information is updated based on the detection of the movement of the merchandise 71 by the reader and writer apparatus 2. If the movement history information of the merchandise 71 includes the information on the number of movements, the comparison unit 1012 acquires the number of movements of the merchandise 71 indicated by the information on the number of movements. If the movement history information of the merchandise 71 includes the movement date and time history information, the comparison unit 1012 acquires the number of movements of the merchandise 71 based on the number of movement dates and times indicated by the movement date and time history information. The number of movement dates and times corresponds to the number of movements. The comparison unit 1012 compares the number of movements of the merchandise 71 with the threshold value. A case in which “the number of movements is five times” is set as the threshold value will be described with reference to FIG. 7. As illustrated in FIG. 7, the number of movements of the merchandise 71 of the merchandise tag ID “00001” stored in the merchandise management information database 1031 is three times. In this case, the comparison unit 1012 determines that the number of movements is not equal to or greater than the threshold value (ACT 14: NO). If the number of movements of the merchandise 71 is six times, the comparison unit 1012 determines that the number of movements is equal to or greater than the threshold value (ACT 14: YES). In the case of an example of the merchandise tag ID “00002” stored in the merchandise management information database 1031, the number of movements of the merchandise 7 is six times. In this case, the comparison unit 1012 determines that the number of movements is equal to or greater than the threshold value.

The comparison unit 1012 may compare the number of movements of the merchandise 71 within a predetermined time with the threshold value based on the movement date and time for each movement of the merchandise 71 indicated by the movement date and time information of the merchandise 71. In this example, the comparison unit 1012 extracts the movement date and time within the predetermined time. The comparison unit 1012 acquires the number of movements of the merchandise 71 within the predetermined time based on the number of extracted movement dates and times. The comparison unit 1012 compares the acquired number of movements of the merchandise 71 with the threshold value. For example, the comparison unit 1012 compares the number of movements of the merchandise 71 “within 24 hours” based on the current date and time with the threshold value indicating that “the number of movements is five times”. A length of the predetermined time can be appropriately set. A case in which the current time is “Oct. 12, 2020, 16:00” will be described with reference to FIG. 7. As illustrated in FIG. 7, the number of movements of the merchandise 71 with the tag ID “00001” is three times, and the number of movements of the merchandise 7 within 24 hours is two times. In the case of an example of the tag ID “00002” stored in the merchandise management information database 1031, the number of movements of the merchandise 7 is six times, and the number of movements of the merchandise 7 within 24 hours is four times. In this case, the comparison unit 1012 determines that the number of movements of the merchandise 7 with the tag ID “00002” is not equal to or greater than the threshold value (ACT 13: NO).

According to this example, the comparison unit 1012 can compare the number of movements of the merchandise 71 within the predetermined time with the threshold value based on the movement date and time for each movement of the merchandise 71. Accordingly, the comparison unit 1012 can compare the number of movements within a certain period of time with the threshold value in consideration of nature of a pathogen that tends to decrease with the lapse of time. Therefore, the server 1 can narrow down the merchandise that requires the hygiene management. The server 1 can provide support for allowing the clerk to efficiently perform the hygiene management of the merchandise.

If the comparison unit 1012 determines that the number of movements of the merchandise 7 is equal to or greater than the threshold value (ACT 14: YES), the processing shifts from ACT 14 to ACT 15. If the comparison unit 1012 determines that the number of movements thereof is not equal to or greater than the threshold value (ACT 14: NO), the processing ends.

The output unit 1013 outputs a notification based on a comparison result of the comparison unit 1012 (ACT 15). In ACT 15, for example, the output unit 1013 outputs the notification related to the movement of the merchandise 71 to the clerk terminal 5 via the communication interface 104. For example, the notification is a text notification indicating that “sterilization and disinfection work are required”. The notification is not limited to the text notification, and may be any display mode such as an icon, a symbol, or the like.

According to this example, the output unit 1013 can output the notification based on the comparison result in which the number of movements of the merchandise 71 and the threshold value are compared with each other. Accordingly, the server 1 can notify the clerk of the merchandise that has a large number of customer contacts and high necessity for performing the hygiene management. The output unit 1013 can output the notification at a timing when the number of movements of the merchandise 71 becomes equal to or greater than the threshold value. Therefore, the server 1 can immediately provide support for allowing the clerk to efficiently perform the hygiene management of the merchandise.

Next, a procedure of information processing by the POS terminal 4 will be described.

FIG. 11 is a flowchart illustrating the procedure of the information processing by the POS terminal 4 according to at least one embodiment.

The processing illustrated in FIG. 11 is applied to an example in which the wireless tag 3 stores the movement history information and an example in which the server 1 stores the movement history information.

First, the clerk registers the purchased merchandise of customer C in the POS terminal 4. For example, the reader and writer 412 reads information such as the merchandise tag ID or the like from the wireless tag 31 attached to the merchandise 71. The processor 401 acquires, from the server 1, the merchandise information correlated with the merchandise tag ID read by the reader and writer 412. For example, the merchandise information is information necessary for settlement processing such as a merchandise name, a JAN code, a price, or the like. The processor 401 performs the settlement processing based on the acquired merchandise information.

The POS terminal 4 performs the following processing in response to the reading of the merchandise tag ID from the wireless tag 31 by the reader and writer 412 in the registration processing of the purchased merchandise.

The acquisition unit 4010 acquires the movement history information of the merchandise 71 (ACT 21). In ACT 21, for example, the acquisition unit 4010 acquires the movement history information of the merchandise 71 from the wireless tag 31 via the reader and writer 412. The acquisition unit 4010 acquires, from the wireless tag 31, at least one of the information on the number of movements and the movement date and time information. The acquisition unit 4010 may acquire, from the server 1, the movement history information of the merchandise 71 correlated with the merchandise tag ID acquired from the wireless tag 31. The acquisition unit 4010 may acquire, from the server 1, at least one of the information on the number of movements and the movement date and time information. This example is an example in which the wireless tag 31 does not store the movement history information and the server 1 stores the movement history information.

The comparison unit 4011 compares the number of movements of the merchandise 71 based on the movement history information of the merchandise 71 acquired by the acquisition unit 4010 with the threshold value (ACT 21). In ACT 21, for example, the comparison unit 4011 acquires the number of movements of the merchandise 71 based on the movement history information of the merchandise 71, in the same manner as that of ACT 14. The comparison unit 4011 compares the number of movements of the merchandise 71 with the threshold value. The comparison performed by the comparison unit 4011 between the number of movements of the merchandise 71 and the threshold value is the same as the processing by the comparison unit 1012.

The comparison unit 4011 may compare the number of movements of the merchandise 71 within the predetermined time with the threshold value based on the movement date and time for each movement of the merchandise 71 indicated by the movement date and time information of the merchandise 71. In this example, the comparison unit 4011 compares the number of movements of the merchandise 71 within the predetermined time with the threshold value, in the same manner as that of the processing by the comparison unit 1012. For example, the comparison unit 4011 compares the number of movements of the merchandise 71 “within 24 hours” based on the current date and time with the threshold value indicating that “the number of movements is five times”.

According to this example, the comparison unit 4011 can compare the number of movements of the merchandise 71 within the predetermined time with the threshold value based on the movement date and time for each movement of the merchandise 71. Accordingly, the comparison unit 4011 can compare the number of movements within a certain period of time with the threshold value in consideration of nature of a pathogen that tends to decrease with the lapse of time. Therefore, the POS terminal 4 can narrow down the merchandise that requires the hygiene management. The POS terminal 4 can provide support for allowing the clerk to efficiently perform the hygiene management of the merchandise.

If the comparison unit 4011 determines that the number of movements is equal to or greater than the threshold value (ACT 22: YES), the processing shifts from ACT 22 to ACT 23. If the comparison unit 4011 determines that the number of movements is not equal to or greater than the threshold value (ACT 22: NO), the processing shifts from ACT 22 to ACT 24.

The output unit 4012 outputs a notification based on a comparison result of the comparison unit 4011 (ACT 23). In ACT 23, for example, the output unit 4012 outputs the notification related to the movement of the merchandise 71 to the display device 409. For example, the notification is a text notification indicating “sterilization and disinfection work is required. Please replace the merchandise.” The notification is not limited to the text notification, and may be any display mode such as an icon, a symbol, or the like. The output unit 4012 may output the notification by using a moving image or a voice instead of the display mode of the text or the like or in addition to the display mode of the text or the like. The display device 409 displays the notification.

According to this example, the output unit 4012 can output the notification based on the comparison result in which the number of movements of the merchandise 71 and the threshold value are compared with each other. Accordingly, the POS terminal 4 can notify a clerk registering the purchased merchandise of the merchandise that has a large number of customer contacts and high necessity for performing the hygiene management. Therefore, the POS terminal 4 can provide support for allowing the clerk to efficiently perform the hygiene management of the merchandise.

The settlement processing unit 4013 performs settlement processing based on the merchandise information correlated with the merchandise tag ID of the wireless tag 31 attached to the merchandise 71 (ACT 24). In ACT 24, for example, the settlement processing unit 4013 displays a settlement screen (not illustrated) on the display device 409 based on the merchandise information of the merchandise 71. The clerk selects a customer's payment method according to the settlement screen, and performs the settlement processing according to the payment method. Since the settlement processing is well-known processing, details thereof will be omitted.

At least one embodiment describes, as one example, the POS terminal 4 with which the clerk performs the operation from the registration of the purchased merchandise to the settlement thereof, and is not limited thereto. At least a part of the functions of the POS terminal 4 may be able to be implemented in a so-called semi-self-service-type settlement apparatus with which the clerk performs the registration of the purchased merchandise and the customer performs the settlement thereof. The semi-self-service-type settlement apparatus is an example of the information processing apparatus, in the same manner as that of the POS terminal 4. At least a part of the functions of the POS terminal 4 may be able to be implemented in a so-called full-self-service POS terminal with which the customer performs operations from the registration of the purchased merchandise to the settlement thereof. The full-self-service POS terminal is an example of the information processing apparatus, in the same manner as that of the POS terminal 4. In these examples, the output unit 4012 may output a notification indicating that the clerk is required to be called as a notification related to the movement of the merchandise 71. For example, the notification indicating that the clerk is required to be called is “this merchandise requires sterilization and disinfection work. The clerk is required to be called”.

At least a part of the functions of the POS terminal 4 may be able to be implemented in a so-called cart POS terminal in which a merchandise scanner and a dedicated terminal operated by the customer are mounted on a cart. At least a part of the functions of the POS terminal 4 may be able to be implemented in a so-called smartphone POS terminal in which merchandise registration is performed with a terminal such as a tablet, a smartphone, or the like. The cart POS terminal and the smartphone POS terminal are examples of the information processing apparatus, in the same manner as that of the POS terminal 4.

At least one embodiment describes the merchandise as an example, and is not limited thereto. At least one embodiment may be performed not only for a commodity that becomes a target for a transaction involving the settlement as the merchandise, but also for a commodity that does not involve the settlement. For example, the commodity that does not involve the settlement is a library book or the like. The description of the “merchandise” may be replaced with the “commodity”.

At last one embodiment describes the reader and writer apparatus 2 as an example of an apparatus provided in the sensing device that detects the movement of the merchandise 7, and is not limited thereto. A camera apparatus may be an example of the apparatus provided in the sensing device that detects the movement of the merchandise 7. In this example, the camera apparatus outputs, to the server 1, the movement date and time information in correlation with the information for identifying the merchandise 7 of which movement is detected, based on the detection of the movement of the merchandise 7. The acquisition unit 1010 of the server 1 acquires, from the camera apparatus via the communication interface 104, the movement date and time information in correlation with the information for identifying the merchandise 7 of which movement is detected. The server 1 may store the movement history information in correlation with the information for identifying the merchandise 7 instead of the merchandise tag ID.

At least one embodiment describes an example in which the POS terminal 4 acquires the movement history information from the wireless tag, and is not limited thereto. The portable reader and writer terminal 6 may acquire the movement history information from the wireless tag. In this example, the portable reader and writer terminal 6 may be able to implement at least a part of the functions of the POS terminal 4. The portable reader and writer terminal 6 is an example of the information processing apparatus, in the same manner as that of the POS terminal 4.

The information processing apparatus may be implemented by one apparatus as described in the server 1 or the POS terminal 4 as an example, or may be implemented by a system in which functions are distributed to a plurality of apparatuses.

The reader and writer apparatus may be implemented by one apparatus as described in the reader and writer apparatus 2 as an example, or may be implemented by a system in which functions are distributed to a plurality of apparatuses.

The program may be transferred in a state of being stored in the electronic apparatus, or may be transferred in a state of not being stored in the electronic apparatus. In the latter case, the program may be transferred via the network or may be transferred in a state of being recorded in a recording medium. The recording medium is a non-temporary (non-transitory) tangible medium. The recording medium is an electronic apparatus readable medium. The recording medium may be formed in any type as long as the recording medium can store the program like a CD-ROM, a memory card, or the like, and can be read by the electronic apparatus.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a processor configured to:
acquire information on a movement history of a commodity based on detection of each movement of the commodity by a sensor;
perform a comparison of the number of movements of the commodity based on the information on the movement history of the commodity with a threshold value; and
output a notification based on the comparison.

2. The apparatus of claim 1,
wherein the sensor includes a reader and writer apparatus,
the reader and writer apparatus configured to output, based on the detection of the movement of the commodity, information on the movement of the commodity to an information recording medium coupled to the commodity,
wherein the information recording medium is configured to store the information on the movement history of the commodity based on the information on the movement of the commodity.

3. The apparatus of claim 2, wherein the processor is configured to acquire the information on the movement history of the commodity from the information recording medium.

4. The apparatus of claim 1, wherein the processor is configured to:
update the information on the movement history of the commodity stored in a memory, based on information on the movement of the commodity based on the detection of the movement of the commodity from the sensor, and
acquire the information on the movement history of the commodity from the memory.

5. The apparatus of claim 1,
wherein the information on the movement history of the commodity includes information indicating a movement date and time for each movement of the commodity.

6. The apparatus of claim 5, wherein the processor is configured to compare the number of movements of the commodity within a predetermined time with the threshold value, based on the movement date and time for each movement of the commodity.

7. An information processing system, comprising:
an information processing apparatus including:
a sensor configured to output information on movement of a commodity based on detection of the movement of the commodity; and
a processor configured to:
acquire information on a movement history of the commodity based on the information on the movement of the commodity output by the sensor;
compare the number of movements of the commodity based on the information on the movement history of the commodity with a threshold value; and
output a notification based on the comparison.

8. A method of operating an information processing apparatus, the method comprising:
acquiring information relating to a movement history of a commodity based on detection of each movement of the commodity by a sensor;
comparing the number of movements of the commodity based on the information relating to the movement history of the commodity with a threshold value; and
outputting a notification based on the comparison.

9. The method of claim 8, further comprising:
outputting, based on the detection of the movement of the commodity, information relating to the movement of the commodity to an information recording medium coupled to the commodity; and
storing the information on the movement history of the commodity based on the information relating to the movement of the commodity.

10. The method of claim 9, further comprising acquiring the information relating to the movement history of the commodity from the information recording medium.

11. The method of claim 8, further comprising:
updating the information relating to the movement history of the commodity stored in a memory, in response to receiving information relating to the movement of the commodity based on the detection of the movement of the commodity from the sensor; and
acquiring the information relating to the movement history of the commodity from the memory.

12. The method of claim 8, wherein the information relating to the movement history of the commodity includes information indicating a movement date and a time for each movement of the commodity.

13. The method of claim 12, further comprising comparing the number of movements of the commodity within a predetermined time with the threshold value, based on the movement date and the time for each movement of the commodity.

14. A non-transitory computer readable medium configured to store instructions, which, when executed by a processor, cause operations to be carried out, the operations comprising:
acquiring information relating to a movement history of a commodity based on detection of each movement of the commodity by a sensor;
comparing the number of movements of the commodity based on the information relating to the movement history of the commodity with a threshold value; and
outputting a notification based on the comparison.

15. The non-transitory computer readable medium of claim 14, wherein the operations further comprise:
outputting, based on the detection of the movement of the commodity, information relating to the movement of the commodity to an information recording medium coupled to the commodity; and
storing the information on the movement history of the commodity based on the information relating to the movement of the commodity.

16. The non-transitory computer readable medium of claim 15, wherein the operations further comprise acquiring the information relating to the movement history of the commodity from the information recording medium.

17. The non-transitory computer readable medium of claim 14, wherein the operations further comprise:
updating the information relating to the movement history of the commodity stored in a memory, in response to receiving information relating to the movement of the commodity based on the detection of the movement of the commodity from the sensor; and
acquiring the information relating to the movement history of the commodity from the memory.

18. The non-transitory computer readable medium of claim 14, wherein the information relating to the movement history of the commodity includes information indicating a movement date and a time for each movement of the commodity.

19. The non-transitory computer readable medium of claim 12, wherein the operations further comprise
comparing the number of movements of the commodity within a predetermined time with the threshold value, based on the movement date and the time for each movement of the commodity.
